(19) United States
(12) Patent Application Publication
(10) Pub. No.: US 2017/0352072 A1
(43) Pub. Date: Dec. 7, 2017

(54) ESTIMATING MERCHANDISE UNIQUENESS

(71) Applicant: International Business Machines Corporation, Armonk, NY (US)

(72) Inventor: Leho Nigul, Ontario (CA)

(21) Appl. No.: 15/175,194

(22) Filed: Jun. 7, 2016

(51) Int. Cl. G06Q 30/02; G06Q 50/00; G06Q 30/06

(52) U.S. Cl. CPC G06Q 30/0283; G06Q 30/0627; G06Q 50/01

(57) ABSTRACT

Estimating a degree of uniqueness of a set of merchandise based on merchandise owned by others in a social network. An analysis is performed on a social network of a user and a degree of uniqueness for a set of merchandise is determined.

### BACKGROUND

The present invention relates generally to the field of data processing, and more particularly to creation or modification of a knowledge processing system.

Some high-end fashion retailers charge set merchandise prices at an increased profit margin based, at least in part, on how “unique” an article is. For example, if a high-end retailer is an exclusive distributor of a fashion line and that fashion line includes a new fabric pattern, the high-end retailer will increase the price (sometimes called a “premium”) because the new fabric pattern cannot be purchased in other locations. One reason a customer of a high-end retailer is willing to pay a premium for merchandise is to ensure other people do not appear at an event wearing matching merchandise. Some merchandise purchases are made for a specific event. For example, a customer does not want to be one of two women wearing matching dresses at a wedding or one of two men wearing matching shirts at an office party. An occurrence of this sort leads to dissatisfaction on the part of the customer, potentially leading to a high-end retailer earning a poor reputation.

### SUMMARY

According to an aspect of the present invention, there is a method, computer program product, and/or system that performs the following operations (not necessarily in the following order): (i) identifying a set of characteristics of a first set of articles of merchandise; (ii) accessing a set of social media accounts for a user; (iii) determining a social circle of the user based, at least in part, on the set of social media accounts; (iv) generating a comparison of the set of characteristics of the first set of articles of merchandise to a set of information within the social circle of the user; (v) generating a uniqueness factor for the first set of articles of merchandise based, at least in part, on the comparison; and (vi) generating a recommendation of a second set of articles of merchandise based, at least in part, on the uniqueness factor. At least accessing the set of social media accounts is performed by computer software running on computer hardware.

### BRIEF DESCRIPTION OF THE DRAWINGS

FIG. 1 depicts a cloud computing environment according to an embodiment of the present invention;

FIG. 2 depicts abstraction model layers according to an embodiment of the present invention;

FIG. 3 is a flowchart showing a first embodiment method performed, at least in part, by a second embodiment system;

FIG. 4 is a block diagram view of a machine logic (e.g., software) portion of the second embodiment system; and

FIG. 5 is a functional block diagram according to a third embodiment system of the

### DETAILED DESCRIPTION

Estimating a degree of uniqueness of a set of merchandise based on merchandise owned by others in a social network. An analysis is performed on a social network of a user and a degree of uniqueness for a set of merchandise is determined. This Detailed Description section is divided into the following sub-sections: (i) Hardware and Software Environment; (ii) Example Embodiment; (iii) Further Comments and/or Embodiments; and (iv) Definitions.

### I. Hardware and Software Environment

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

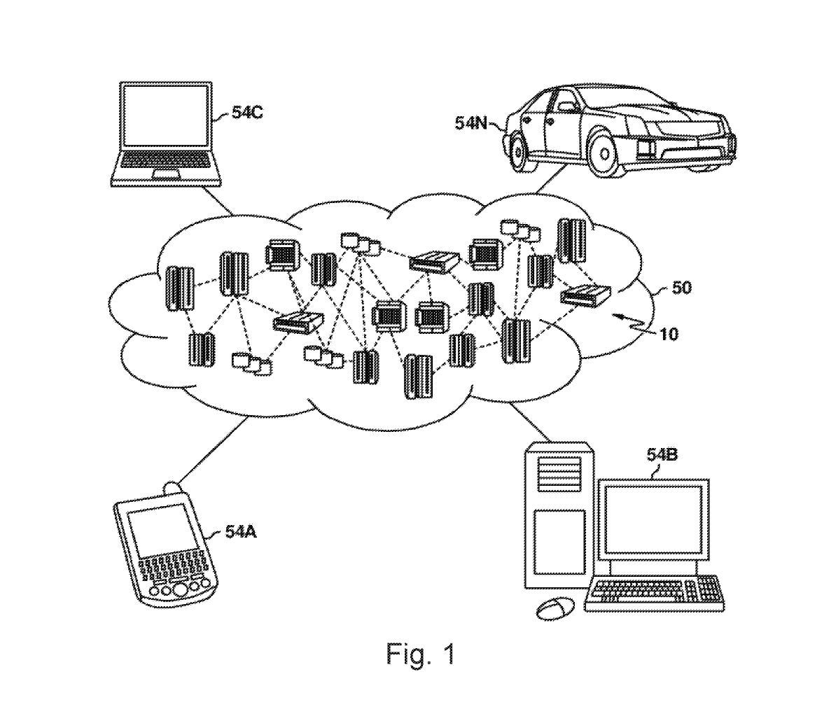

Referring now to FIG. 1, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

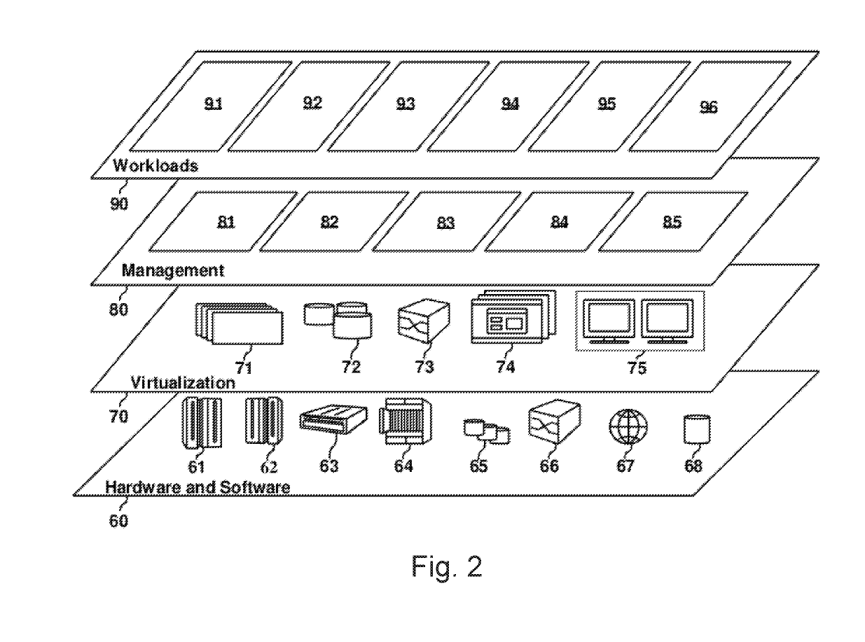

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and merchandise uniqueness processing 96.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

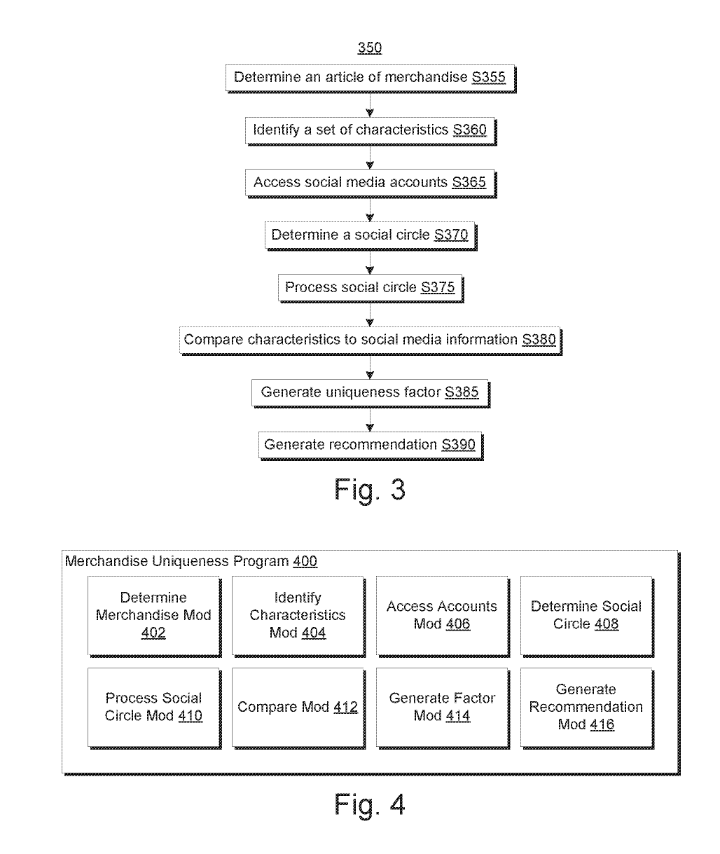

FIG. 3 shows flowchart 350 depicting a method according to the present invention. Some embodiments provide an overall reduction in consumption of computing resources, on average. In many embodiments, a computing device is configured to provide functionality to aid a user in reaching an endpoint. Such an endpoint may be, for example, when an answer to a query is presented to the user. The amount of time required, user input, and consumption of network bandwidth, electrical power, hardware, and software resources in order to reach that endpoint reflect a level of efficiency for the computing device when performing that function. For example, in a first scenario a user spends three hours searching through social media and online venues in order to locate a unique item. In this example, a unique item is an item that has unique characteristics that set it apart from other items of the same type (e.g., types of clothing and accessories such as, but are not limited to, jewelry, shoes, belts, pants, shirts etc.). However, in a second scenario, by utilizing a method according to the present invention that same user is presented with the same conclusion, i.e., the same endpoint, in ten minutes. When the amount of time and computing resources consumed in the first scenario are compared to the amount of time and computing resources consumed in the second scenario it is clear that the computing device was more efficient when utilizing the method according to the present invention. As such, certain functions of the computing device clearly become more efficient when utilizing a method according to the present invention.

FIG. 4 shows program 400 which performs at least some of the method operations of flowchart 350. This method and associated software will now be discussed, over the course of the following paragraphs, with extensive reference to FIG. 3 (for the method operation blocks) and FIG. 4 (for the software blocks). One physical location where program 400 of FIG. 4 may be stored is in storage devices 65 (see FIG. 2). In this example, John (a user) is participating in a competition with his coworkers to determine who can wear the most outlandish socks in the office.

Processing begins at operation S355, where determine merchandise module (“mod”) 402 determines an article of merchandise. In some embodiments of the present invention, determine merchandise mod 402 determines an article of merchandise. In some of these embodiments, determine merchandise mod 402 received an article of merchandise as an input. In other embodiments, determine merchandise mod 402 determines an article of merchandise based, at least in part, on a set of factors. In some of these embodiments, a set of factors includes, but is not limited to, one or more of: (i) a web page browsing history of a user; (ii) a set of magazine subscriptions for the user; (iii) a set of recent purchases by the user; (iv) a set of recent location data (e.g., the user browsed a department store window); (v) a set of recent telephone calls by the user; and/or (vi) a set of recent television advertisements seen by the user. In additional embodiments, determine merchandise mod 402 determines a set of articles of merchandise (e.g., a suit and a tie, a dress and a purse, or a belt and a pair of shoes). In this example, determine merchandise mod 402 receives as an input, from John, a pair of socks on a website of a retail store.

Processing proceeds to operation S360, where identify characteristics mod 404 identifies a set of characteristics of an article of merchandise. In some embodiments of the present invention, identify characteristics mod 404 identifies a set of characteristics of an article of merchandise. In other embodiments, identify characteristics mod 404 identifies a set of characteristics for each article of merchandise in a set of articles of merchandise. Alternatively, identify characteristics mod 404 identifies a set of characteristics for a set of articles of merchandise. In some embodiments, a set of characteristics of an article of merchandise includes, but is not limited to, one or more of: (i) a material of the article of merchandise (e.g., wool, cotton, leather) ; (ii) a pattern of the article of merchandise (e.g., plaid, hounds tooth, argyle, based on a national flag); (iii) a color of the article of merchandise; (iv) a size of the article of merchandise; (v) a finish of the article of merchandise (e.g., matte, sheen, glossy); and/or (vi) a texture of the article of merchandise. In alternative embodiments, identify characteristics mod 404 identifies a set of characteristics of an article of merchandise as an input. In other embodiments, identify characteristics mod 404 identifies a set of characteristics of an article of merchandise based, at least in part, on images of the article of merchandise (e.g., pictures in a magazine, videos on a television program). Alternatively, identify characteristics mod 404 identifies a set of characteristics of an article of merchandise based, at least in part, on a natural language processing of a description of the article of merchandise (e.g., a description in a catalog published by a manufacturer of the article of merchandise). In some embodiments, identify characteristics mod 404 identifies a set of metadata about an article of merchandise. In some embodiments of the present invention, a set of metadata includes, but is not limited to, at least one of: (i) a brand; and/or (ii) a location of a transaction. In some embodiments, identify characteristics mod 404 includes an ontology of design terms. In some of those embodiments, identify characteristics mod 404 includes an ontology of design elements (e.g., colors, patterns). In some further embodiments, identify characteristics mod 404 includes an ontology of fashion design elements (e.g., styles, materials, fabrics). In this example, identify characteristics mod 404 receives an image of a pair of socks from John and identifies characteristics of the socks as: plaid with a green base and red accents inlaid with images of a coat of arms.

Processing proceeds to operation S365, where access accounts mod 406 access a set of social media accounts of a user. In some embodiments of the present invention, access accounts mod 406 accesses a set of social media accounts of a user. In further embodiments, access accounts mod 406 receives, as an input, a set of credentials for a set of social media accounts of a user. Alternatively, access accounts mod 406 registers a set of social media accounts of a user. In this example, access accounts mod 406 receives account credentials from John for his various social media accounts.

Processing proceeds to operation S370, where determine social circle mod 408 determines a social circle for a user. In some embodiments of the present invention, determine social circle mod 408 determines a social circle for a user. A social circle is sometimes also called a social web. In other embodiments, determine social circle mod 408 crawls a set of social media accounts of a user. In some of these embodiments, determine social circle mod 408 crawls a set of social media accounts of a user to determine a social circle for the user. Alternatively, determine social circle mod 408 crawls a set of social media accounts of a user to determine a social web for the user. In some embodiments, determine social circle mod 408 limits a social circle based, at least in part, on a number of degrees of separation. In other embodiments, determine social circle mod 408 limits a social circle based, at least in part, on an invitation to an event. In alternative embodiments, determine social circle mod 408 limits a social circle based, at least in part, on planned attendance of an event. In further embodiments, determine social circle mod 408 receives a social circle as an input. In this example, determine social circle mod 408 receives a social circle as an input from John; John limits the social circle to those coworkers participating in the competition. Then, determine social circle mod 408 locates social media accounts corresponding to John's coworkers on a variety of social media platforms.

Processing proceeds to operation S375, where process social circle mod 410 processes a social circle. In some embodiments of the present invention, process social circle mod process a social circle. In other embodiments, process social circle mod 410 uses image recognition techniques on a set of social media accounts. In further embodiments, process social circle mod 410 uses image recognition techniques to identify a set of articles of merchandise in a social media account. Some articles of merchandise appear in photographs associated with a social media account. Other articles of merchandise are discussed in a set of written posts (of varying length) associated with a social media account. Additional articles of merchandise appear on websites reached through a link posted on a social media account. In other embodiments, process social circle mod 410 uses neuro-linguistic programming techniques on a set of written posts associated with a social media account. In further embodiments, process social circle mod 410 uses natural language programming to identify a set of articles of merchandise associated with a social media account. In some of those embodiments, process social circle mod 410 uses natural language processing on a set of written posts associated with a social media account. In some embodiments, process social circle mod 410 only analyzes a set of written posts associated with a social media account, without analyzing a set of images associated with the social media account. Alternatively, process social circle mod 410 only analyzes a set of images associated with a social media account, without analyzing a set of written posts associated with the social media account. In some embodiments of the present invention, process social circle mod 410 includes an ontology of design characteristics. In some alternative embodiments, process social circle mod 410 includes an ontology of fashion design characteristics (e.g., stripes, plaid, wool). In additional embodiments, process social circle mod 410 uses natural language programming to identify a set of characteristics in a set of written posts associated with a social media account. Alternatively, process social circle mod 410 uses image recognition techniques to identify a set of characteristics in a set of images associated with a social media account. In further alternative embodiments, process social circle mod 410 uses a combination of natural language programming and image recognition techniques to analyze a set of written posts associated with a social media account and/or a set of images associated with the social media account.

Processing proceeds to operation S380, where compare mod 412 compares a set of characteristics of an article of merchandise to a set of social media information. In some embodiments of the present invention, compare mod 412 compares a set of characteristics of an article of merchandise to a set of social media information. In other embodiments, compare mod 412 compares an article of merchandise determined by determine merchandise mod 402 in operation S355 against a set of social media information determined by process social circle mod 410 in operation S375. In further embodiments, compare mod 412 compares metadata for an article of merchandise determined by determine merchandise mod 402 in operation S355 against a set of social media information determined by process social circle mod 410 in operation S375. In other embodiments, compare mod 412 also compares a set of characteristics of a set of articles of merchandise to a set of social media information, and the set of articles of merchandise correspond to an article of clothing (e.g., socks, pants, dress). In some alternative embodiments, compare mod 412 also compares a set of characteristics of a set of articles of merchandise to a set of social media information, and the set of articles of merchandise correspond to articles of merchandise owned by a user. In further alternative embodiments, compare mod 412 also compares a set of characteristics of a set of articles of merchandise to a set of social media information, and the set of articles of merchandise correspond to articles of merchandise not owned by a user. In other embodiments, compare mod 412 generates a comparison for a set of articles of merchandise, and the set of articles of merchandise correspond to an article of clothing (e.g., socks, pants, dress). In some of those embodiments, compare mod 412 determines a similarity in design based, at least in part, on a quantity of characteristics that exist both a set of characteristics of an article of merchandise and a set of social media information. In this example, compare mod 412 compares John's sock determined by determine merchandise mod 402 in operation S355 (and a variety of other socks owned by John) against social media account information for the coworkers identified as John's social circle by determine social circle mod 408 in operation S365.

Processing proceeds to operation S385, where generate factor mod 414 generates a uniqueness factor for an article of merchandise. In some embodiments of the present invention, generate factor mod 414 generates a uniqueness factor for an article of merchandise determined by determine merchandise mod 402 in operation S355. In other embodiments, generate factor mod 414 generates a uniqueness factor for a set of articles of merchandise owned by a user. Alternatively, generate factor mod 414 generates a uniqueness factor for a set of articles of merchandise not owned by a user. In some of these embodiments, generate factor mod 414 generates a set of uniqueness factors corresponding to a set of articles of merchandise on a website of a retailer. In further embodiments, generate factor mod 414 ranks a set of articles of merchandise based, at least in part, on a set of uniqueness factors corresponding to the set of articles of merchandise. In some embodiments of the present invention, generate factor mod 414 generates a uniqueness factor based, at least in part, on a comparison generated by compare mod 412 in operation S380. In alternative embodiments, generate factor mod 414 generates a uniqueness factor for a set of articles of merchandise, and the set of articles of merchandise correspond to an article of clothing (e.g., socks, pants, dress). In this example, generate factor mod 414 generates a uniqueness factor for John's socks of 95%. Here, generate factor mod 414 additionally generates a uniqueness factor for the rest of John's socks; none of these uniqueness factors is greater than 95%.

Processing terminates at operation S390, where generate recommendation mod 416 generates a set of recommendations. In some embodiments of the present invention, generate recommendation mod 416 generates a set of recommendations of articles of merchandise. In some embodiments, generate recommendation mod 416 generates a set of recommendations of articles of merchandise that includes the article of merchandise determined by determine merchandise mod 302 in operation S355. Alternatively, generate recommendation mod 416 generates a set of recommendations of articles of merchandise that does not include the article of merchandise determined by determine merchandise mod 402 in operation S355. In other embodiments, generate recommendation mod 416 generates a set of recommendations of articles of merchandise that includes a set of articles of merchandise owned by a user. Alternatively, generate recommendation mod 416 generates a set of recommendations of articles of merchandise that includes a set of articles of merchandise not owned by a user. In further embodiments, generate recommendation mod 416 generates a set of recommendations based, at least in part, on a uniqueness factor generated by generate factor mod 414 in operation S385. In some embodiments of the present invention, generate recommendation mod 416 ranks a set of recommendations based, at least in part, on a uniqueness factor. Generate recommendation mod 416 can rank the various artifacts in a variety of manners. In some alternative embodiments, generate recommendation mod 416 ranks a set of articles of merchandise based, at least in part, on a combination of articles of merchandise. In this example, generate recommendation mod 416 generates a set of recommendations for John and the set of recommendations includes the socks that are plaid with a green base and red accents inlaid with images of a coat of arms, which John had input in operation S355.

### III. Further Comments and/or Embodiments

Some embodiments of the present invention analyze a set of social networks of a user. In some embodiments, a merchandise uniqueness sub-system analyzes a set of social networks of a shopper. In other embodiments, a merchandise uniqueness sub-system analyzes a social circle of a user. In further embodiments, a merchandise uniqueness sub-system estimates a degree of uniqueness of an article of merchandise. In some embodiments, a merchandise uniqueness sub-system determines a degree of uniqueness of an article of merchandise. In some of these embodiments, a merchandise uniqueness sub-system estimates a degree of uniqueness of an article of merchandise within a social circle of a user. In alternative embodiments, a merchandise uniqueness sub-system suggests an article of merchandise to a user. In additional embodiments, a merchandise uniqueness sub-system suggests an article of merchandise to a user based, at least in part, on a degree of uniqueness for the article of merchandise. In some embodiments, a merchandise uniqueness sub-system operates as SaaS.

Some embodiments of the present invention mine a social network of a user. In some embodiments, a merchandise uniqueness sub-system mines a social network of a user to determine a uniqueness factor for an article of merchandise. In other embodiments, a merchandise uniqueness sub-system mines a social network of a user to determine if another individual possesses an article of merchandise. In further embodiments, a merchandise uniqueness sub-system determines an individual in a social network of a user possesses an article of merchandise. In some embodiments, a merchandise uniqueness sub-system receives a social network as an input. Alternatively, a merchandise uniqueness sub-system determines a social network based on a preset variable. In other embodiments, a merchandise uniqueness sub-system determines a social network includes three degrees of separation. In alternative embodiments, a merchandise uniqueness sub-system receives as an input a number of degrees of separation for determining a social network. In alternative embodiments, a merchandise uniqueness sub-system determines a social network to include people invited to an event. In further alternative embodiments, a merchandise uniqueness sub-system determines a social network to include people attending an event.

Some embodiments of the present invention determine a uniqueness factor for an article of merchandise before a user purchases the article of merchandise. Alternative embodiments determine a uniqueness factor for an article of merchandise after a user purchases the article of merchandise. In some embodiments of the present invention, a merchandise uniqueness sub-system determines a uniqueness factor for an article of merchandise while a user is browsing a retailer website.

In some embodiments of the present invention, a merchandise uniqueness sub-system associates an image of an article of merchandise with a set of metadata of the article of merchandise. In other embodiments, a merchandise uniqueness sub-system crawls a set of profiles associated with a set of social network contacts in a social circle. In further embodiments, a merchandise uniqueness sub-system crawls a set of profiles to determine a match between a first article of merchandise (from a user) and a second article of merchandise (from the set of profiles). In some embodiments of the present invention, a merchandise uniqueness sub-system uses image analysis, video analysis, and/or text analysis to determine a match of a first article of merchandise and a second article of merchandise.

Some embodiments of the present invention use probabilities to describe a uniqueness factor. In some embodiments, a merchandise uniqueness sub-system decreases a uniqueness factor for a first article of merchandise as a set of characteristics corresponding to the first article of merchandise are more similar to a set of characteristics corresponding to a second article of merchandise. In some embodiments, a merchandise uniqueness sub-system increases a uniqueness factor for a first article of merchandise as a set of characteristics corresponding to the first article of merchandise are less similar to a set of characteristics corresponding to a second article of merchandise.

Some embodiments of the present invention may include one, or more, of the following features, characteristics, and/or advantages: (i) generating a merchandise uniqueness factor for a social circle; (ii) receiving a request to estimate a uniqueness value of an article of merchandise for a social circle associated with a user; (iii) receiving a request to estimate a uniqueness factor of an article of merchandise for a social circle associated with a user responsive to the user expressing an interest in the article of merchandise; (iv) determining a social circle comprises an entire social network; (v) determining a social circle comprises a group of people invited to an event; (vi) crawling a social circle of a user using an image of an article of merchandise and metadata for the article of merchandise to locate a match within the social circle; (vii) crawling a social circle of a user using an image of an article of merchandise and metadata for the article of merchandise to locate a match within the social circle responsive to receiving a request to estimate a uniqueness factor; (viii) receiving permission from a user to estimate a uniqueness factor; and/or (ix) requiring data including image data, video data, image analysis, and/or text analysis within a social circle associated with a user to locate a match

Some embodiments of the present invention may include one, or more, of the following features, characteristics, and/or advantages: (i) identifying a uniqueness factor as low responsive to determination of a match; (ii) identifying a uniqueness factor medium responsive to a determination of an indirect match; (iii) generating a uniqueness factor scale for a set of indirect matches; (iv) configuring and/or defining a uniqueness factor scale for a set of indirect matches; and/or (v) identifying a uniqueness factor as high responsive to a determination of neither a match and/or an indirect match.

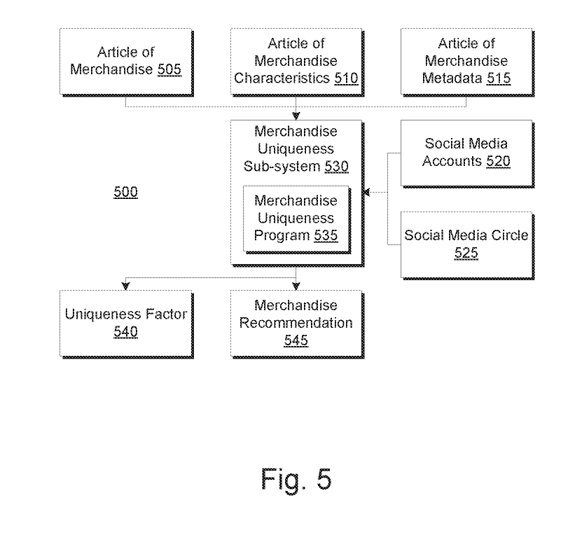

FIG. 5 is a functional block diagram showing merchandise uniqueness environment 500. Merchandise uniqueness environment 500 includes: article of merchandise 505; article of merchandise characteristics 510; article of merchandise metadata 515; social media accounts 520; social media circle 525; merchandise uniqueness sub-system 530; uniqueness factor 540; and merchandise recommendation 545. Merchandise uniqueness sub-system 530 includes: merchandise uniqueness program 535.

Article of merchandise 505 is an article of merchandise for which a user desires an analysis. Article of merchandise 505 is sent as an input to merchandise uniqueness sub-system 525. Article of merchandise characteristics 510 is a set of characteristics for article of merchandise 505. In some embodiments, article of merchandise characteristics 510 is sent as an input to merchandise uniqueness sub-system 525. In alternative embodiments, merchandise uniqueness sub-system 525 extracts article of merchandise characteristics 510 from article of merchandise 505. Article of merchandise metadata 515 is a set of metadata for article of merchandise 505. In some embodiments, article of merchandise metadata 515 is sent as an input to merchandise uniqueness sub-system 525. In alternative embodiments, merchandise uniqueness sub-system 525 extracts article of merchandise metadata 515 from article of merchandise 505.

Social media accounts 520 is a set of social media accounts for a user. In some embodiments of the present invention, social media accounts 520 includes every social media account for a user. Alternatively, social media accounts 520 includes a subset of every social media account for a user. In some embodiments, social media accounts 520 is sent as an input to merchandise uniqueness sub-system 525. In alternative embodiments, merchandise uniqueness sub-system 525 determines social media accounts 520. Social media circle 525 is a set of social media contacts for a user. In some embodiments of the present invention, social media circle 525 includes every social media contact for a user. Alternatively, social media circle 525 includes a subset of every social media contact for a user. In some embodiments, social media circle 525 is sent as an input to merchandise uniqueness sub-system 525. In alternative embodiments, merchandise uniqueness sub-system 525 determines social media circle 525 based, at least in part, on social media accounts 520.

Merchandise uniqueness sub-system 530 is, in many respects, representative of the various computer sub-systems in the present invention. Accordingly, several portions of merchandise uniqueness sub-system 530 will now be discussed in the following paragraphs. Merchandise uniqueness sub-system 530 may be a laptop computer, a tablet computer, a netbook computer, a personal computer (PC), a desktop computer, a personal digital assistant (PDA), a smart phone, or any programmable electronic device capable of communicating with client sub-systems via a communication network.

Merchandise uniqueness program 535 performs similar functions and operations to merchandise uniqueness program 400 (FIG. 4). Merchandise uniqueness program 535 is a collection of machine readable instructions and/or data that is used to create, manage, and control certain software functions. Merchandise uniqueness program 535 may include both substantive data (that is, the type of data stored in a database) and/or machine readable and performable instructions.

Uniqueness factor 540 is a value describing a uniqueness of article of merchandise 505. In some embodiments of the present invention, merchandise uniqueness sub-system expresses uniqueness factor 540 as a percentage. In other embodiments, merchandise uniqueness sub-system expresses uniqueness factor 540 as a number. In further embodiments, merchandise uniqueness sub-system expresses uniqueness factor 540 as a number on a scale from 0 to 100.

Merchandise recommendation 545 is a recommendation of a set of articles of merchandise for a user. In some embodiments of the present invention, merchandise uniqueness sub-system 530 expresses merchandise recommendation 545 as an output. In other embodiments, merchandise uniqueness sub-system 530 displays merchandise recommendation 545 as a set of articles of merchandise for a user. In further embodiments merchandise uniqueness sub-system 530 determines merchandise recommendation 545 based, at least in part, on uniqueness factor 540. In some embodiments, merchandise recommendation 545 includes article of merchandise 505. Alternatively, merchandise recommendation 545 does not include article of merchandise 505. In other embodiments, merchandise recommendation 545 includes a set of articles of merchandise that a user must purchase. Alternatively, merchandise recommendation 545 includes a set of articles of merchandise that a user already owns.

Some embodiments of the present invention may include one, or more, of the following features, characteristics, and/or advantages: (i) identifying a set of characteristics of a first set of articles of merchandise; (ii) accessing a set of social media accounts for a user; (iii) determining a social circle of a user based, at least in part, on a set of social media accounts; (iv) generating a comparison of a set of characteristics of a first set of articles of merchandise to a set of information within a social circle of a user; (v) generating a uniqueness factor for a first set of articles of merchandise based, at least in part, on a comparison; and/or (vi) generating a recommendation of a second set of articles of merchandise based, at least in part, on a uniqueness factor.

Some embodiments of the present invention may include one, or more, of the following features, characteristics, and/or advantages: (i) generating a comparison of a set of characteristics of a first set of articles of merchandise to a set of information within a social circle of a user further includes determining a set of social media contacts in the social circle, wherein: (a) the set of social media contacts are attending an event, and (b) the user is attending the event. In other embodiments of the present invention; (ii) identifying a set of social media posts for a set of social media contacts; (iii) identifying a third set of articles of merchandise within a set of social media posts; (iv) identifying a set of characteristics of a third set of articles of merchandise; and/or (v) comparing a set of characteristics of a first set of articles of merchandise and a set of characteristics of a third set of articles of merchandise.

Some embodiments of the present invention may include one, or more, of the following features, characteristics, and/or advantages: (i) a second set of articles of merchandise includes at least a first article of merchandise in a first set of articles of merchandise; (ii) identifying a set of characteristics of a first set of articles of merchandise further includes performing a natural language processing on a description of the first set of articles of merchandise; (iii) identifying a set of metadata of a first set of articles of merchandise; (iv) generating a comparison is further based, at least in part, on a set of metadata of a first set of articles of merchandise; (v) a uniqueness factor identifies a first set of articles of merchandise as unique with regard to a social circle; (vi) a second set of articles of merchandise is equivalent to a first set of articles of merchandise; and/or (vii) a uniqueness factor is a percentage.

### IV. Definitions

“Present invention” does not create an absolute indication and/or implication that the described subject matter is covered by the initial set of claims, as filed, by any as-amended set of claims drafted during prosecution, and/or by the final set of claims allowed through patent prosecution and included in the issued patent. The term “present invention” is used to assist in indicating a portion or multiple portions of the disclosure that might possibly include an advancement or multiple advancements over the state of the art. This understanding of the term “present invention” and the indications and/or implications thereof are tentative and provisional and are subject to change during the course of patent prosecution as relevant information is developed and as the claims may be amended.

“Embodiment,” see the definition for “present invention.”

“And/or” is the inclusive disjunction, also known as the logical disjunction and commonly known as the “inclusive or.” For example, the phrase “A, B, and/or C,” means that at least one of A or B or C is true; and “A, B, and/or C” is only false if each of A and B and C is false.

A “set of” items means there exists one or more items; there must exist at least one item, but there can also be two, three, or more items. A “subset of” items means there exists one or more items within a grouping of items that contain a common characteristic.

A “plurality of” items means there exists at more than one item; there must exist at least two items, but there can also be three, four, or more items.

“Includes” and any variants (e.g., including, include, etc.) means, unless explicitly noted otherwise, “includes, but is not necessarily limited to.”

A “user” or a “subscriber” includes, but is not necessarily limited to: (i) a single individual human; (ii) an artificial intelligence entity with sufficient intelligence to act in the place of a single individual human or more than one human; (iii) a business entity for which actions are being taken by a single individual human or more than one human; and/or (iv) a combination of any one or more related “users” or “subscribers” acting as a single “user” or “subscriber.”

The terms “receive,” “provide,” “send,” “input,” “output,” and “report” should not be taken to indicate or imply, unless otherwise explicitly specified: (i) any particular degree of directness with respect to the relationship between an object and a subject; and/or (ii) a presence or absence of a set of intermediate components, intermediate actions, and/or things interposed between an object and a subject.

A “module” is any set of hardware, firmware, and/or software that operatively works to do a function, without regard to whether the module is: (i) in a single local proximity; (ii) distributed over a wide area; (iii) in a single proximity within a larger piece of software code; (iv) located within a single piece of software code; (v) located in a single storage device, memory, or medium; (vi) mechanically connected; (vii) electrically connected; and/or (viii) connected in data communication. A “sub-module” is a “module” within a “module.”

A “computer” is any device with significant data processing and/or machine readable instruction reading capabilities including, but not necessarily limited to: desktop computers; mainframe computers; laptop computers; field-programmable gate array (FPGA) based devices; smart phones; personal digital assistants (PDAs); body-mounted or inserted computers; embedded device style computers; and/or application-specific integrated circuit (ASIC) based devices.

“Electrically connected” means either indirectly electrically connected such that intervening elements are present or directly electrically connected. An “electrical connection” may include, but need not be limited to, elements such as capacitors, inductors, transformers, vacuum tubes, and the like.

“Mechanically connected” means either indirect mechanical connections made through intermediate components or direct mechanical connections. “Mechanically connected” includes rigid mechanical connections as well as mechanical connection that allows for relative motion between the mechanically connected components. “Mechanically connected” includes, but is not limited to: welded connections; solder connections; connections by fasteners (e.g., nails, bolts, screws, nuts, hook-and-loop fasteners, knots, rivets, quick-release connections, latches, and/or magnetic connections); force fit connections; friction fit connections; connections secured by engagement caused by gravitational forces; pivoting or rotatable connections; and/or slidable mechanical connections.

A “data communication” includes, but is not necessarily limited to, any sort of data communication scheme now known or to be developed in the future. “Data communications” include, but are not necessarily limited to: wireless communication; wired communication; and/or communication routes that have wireless and wired portions. A “data communication” is not necessarily limited to: (i) direct data communication; (ii) indirect data communication; and/or (iii) data communication where the format, packetization status, medium, encryption status, and/or protocol remains constant over the entire course of the data communication.

The phrase “without substantial human intervention” means a process that occurs automatically (often by operation of machine logic, such as software) with little or no human input. Some examples that involve “no substantial human intervention” include: (i) a computer is performing complex processing and a human switches the computer to an alternative power supply due to an outage of grid power so that processing continues uninterrupted; (ii) a computer is about to perform resource intensive processing and a human confirms that the resource-intensive processing should indeed be undertaken (in this case, the process of confirmation, considered in isolation, is with substantial human intervention, but the resource intensive processing does not include any substantial human intervention, notwithstanding the simple yes-no style confirmation required to be made by a human); and (iii) using machine logic, a computer has made a weighty decision (for example, a decision to ground all airplanes in anticipation of bad weather), but, before implementing the weighty decision the computer must obtain simple yes-no style confirmation from a human source.

“Automatically” means “without any human intervention.”

The term “real time” (and the adjective “real-time”) includes any time frame of sufficiently short duration as to provide reasonable response time for information processing as described. Additionally, the term “real time” (and the adjective “real-time”) includes what is commonly termed “near real time,” generally any time frame of sufficiently short duration as to provide reasonable response time for on-demand information processing as described (e.g., within a portion of a second or within a few seconds). These terms, while difficult to precisely define, are well understood by those skilled in the art.

What is claimed is:

1. A method comprising:
identifying a set of characteristics of a first set of articles of merchandise;
accessing a set of social media accounts for a user;
determining a social circle of the user based, at least in part, on the set of social media accounts;
generating a comparison of the set of characteristics of the first set of articles of merchandise to a set of information within the social circle of the user;
generating a uniqueness factor for the first set of articles of merchandise based, at least in part, on the comparison; and
generating a recommendation of a second set of articles of merchandise based, at least in part, on the uniqueness factor;
wherein:
at least accessing the set of social media accounts is performed by computer software running on computer hardware.

2. The method of claim 1, wherein generating the comparison of the set of characteristics of the first set of articles of merchandise to the set of information within the social circle of the user further includes:
determining a set of social media contacts in the social circle, wherein:
the set of social media contacts are attending an event, and
the user is attending the event;
identifying a set of social media posts for the set of social media contacts;
identifying a third set of articles of merchandise within the set of social media posts;
identifying a set of characteristics of the third set of articles of merchandise; and
comparing the set of characteristics of the first set of articles of merchandise and the set of characteristics of the third set of articles of merchandise.

3. The method of claim 1, wherein the second set of articles of merchandise includes at least a first article of merchandise in the first set of articles of merchandise.

4. The method of claim 1, wherein identifying the set of characteristics of the first set of articles of merchandise further includes:
performing a natural language processing on a description of the first set of articles of merchandise.

5. The method of claim 1, further comprising:
identifying a set of metadata of the first set of articles of merchandise;
wherein:
generating the comparison is further based, at least in part, on the set of metadata of the first set of articles of merchandise.

6. The method of claim 1, wherein:
the uniqueness factor identifies the first set of articles of merchandise as unique with regard to the social circle; and
the second set of articles of merchandise is equivalent to the first set of articles of merchandise.

7. The method of claim 1, wherein the uniqueness factor is a percentage.

8. A computer program product comprising:
a computer readable storage medium having stored thereon:
first instructions executable by a device to cause the device to identify a set of characteristics of a first set of articles of merchandise;
second instructions executable by a device to cause the device to access a set of social media accounts for a user;
third instructions executable by a device to cause the device to determine a social circle of the user based, at least in part, on the set of social media accounts;
fourth instructions executable by a device to cause the device to generate a comparison of the set of characteristics of the first set of articles of merchandise to a set of information within the social circle of the user;
fifth instructions executable by a device to cause the device to generate a uniqueness factor for the first set of articles of merchandise based, at least in part, on the comparison; and
sixth instructions executable by a device to cause the device to generate a recommendation of a second set of articles of merchandise based, at least in part, on the uniqueness factor.

9. The computer program product of claim 8, wherein fourth instructions to generate the comparison of the set of characteristics of the first set of articles of merchandise to the set of information within the social circle of the user further include:
seventh instructions executable by a device to cause the device to determine a set of social media contacts in the social circle, wherein:
the set of social media contacts are attending an event, and
the user is attending the event;
eighth instructions executable by a device to cause the device to identify a set of social media posts for the set of social media contacts;
ninth instructions executable by a device to cause the device to identify a third set of articles of merchandise within the set of social media posts;
tenth instructions executable by a device to cause the device to identify a set of characteristics of the third set of articles of merchandise; and
eleventh instructions executable by a device to cause the device to compare the set of characteristics of the first set of articles of merchandise and the set of characteristics of the third set of articles of merchandise.

10. The computer program product of claim 8, wherein the second set of articles of merchandise includes at least a first article of merchandise in the first set of articles of merchandise.

11. The computer program product of claim 8, wherein first instructions to identify the set of characteristics of the first set of articles of merchandise further includes:
seventh instructions executable by a device to cause the device to perform a natural language processing on a description of the first set of articles of merchandise.

12. The computer program product of claim 8, further comprising:
seventh instructions executable by a device to cause the device to identify a set of metadata of the first set of articles of merchandise;
wherein:
fourth instructions to generate the comparison are further based, at least in part, on the set of metadata of the first set of articles of merchandise.

13. The computer program product of claim 8, wherein:
the uniqueness factor identifies the first set of articles of merchandise as unique with regard to the social circle; and
the second set of articles of merchandise is equivalent to the first set of articles of merchandise.

14. The computer program product of claim 8, wherein the uniqueness factor is a percentage.

15. A computer system comprising:
a processor set; and
a computer readable storage medium;
wherein:
the processor set is structured, located, connected, and/or programmed to run instructions stored on the computer readable storage medium; and
the instructions include:
first instructions executable by a device to cause the device to identify a set of characteristics of a first set of articles of merchandise;
second instructions executable by a device to cause the device to access a set of social media accounts for a user;
third instructions executable by a device to cause the device to determine a social circle of the user based, at least in part, on the set of social media accounts;
fourth instructions executable by a device to cause the device to generate a comparison of the set of characteristics of the first set of articles of merchandise to a set of information within the social circle of the user;
fifth instructions executable by a device to cause the device to generate a uniqueness factor for the first set of articles of merchandise based, at least in part, on the comparison; and
sixth instructions executable by a device to cause the device to generate a recommendation of a second set of articles of merchandise based, at least in part, on the uniqueness factor.

16. The computer system of claim 15, wherein fourth instructions to generate the comparison of the set of characteristics of the first set of articles of merchandise to the set of information within the social circle of the user further include:
seventh instructions executable by a device to cause the device to determine a set of social media contacts in the social circle, wherein:
the set of social media contacts are attending an event, and
the user is attending the event;
eighth instructions executable by a device to cause the device to identify a set of social media posts for the set of social media contacts;
ninth instructions executable by a device to cause the device to identify a third set of articles of merchandise within the set of social media posts;
tenth instructions executable by a device to cause the device to identify a set of characteristics of the third set of articles of merchandise; and
eleventh instructions executable by a device to cause the device to compare the set of characteristics of the first set of articles of merchandise and the set of characteristics of the third set of articles of merchandise.

17. The computer system of claim 15, wherein the second set of articles of merchandise includes at least a first article of merchandise in the first set of articles of merchandise.

18. The computer system of claim 15, wherein first instructions to identify a set of characteristics of a first set of articles of merchandise further includes:
seventh instructions executable by a device to cause the device to perform a natural language processing on a description of the first set of articles of merchandise.

19. The computer system of claim 15, further comprising:
seventh instructions executable by a device to cause the device to identify a set of metadata of the first set of articles of merchandise;
wherein:
fourth instructions to generate the comparison are further based, at least in part, on the set of metadata of the first set of articles of merchandise.

20. The computer system of claim 15, wherein:
the uniqueness factor identifies the first set of articles of merchandise as unique with regard to the social circle; and
the second set of articles of merchandise is equivalent to the first set of articles of merchandise.
